(19) United States
(12) Patent Application Publication
(10) Pub. No.: US 2024/0356389 A1
(43) Pub. Date: Oct. 24, 2024

(54) ROTARY ELECTRIC MACHINE

(71) Applicants: NIDEC CORPORATION, Kyoto (JP); National University Corporation YOKOHAMA National University, Kanagawa (JP)

(72) Inventors: Masanori WATAHIKI, Kyoto (JP); Kan AKATSU, Kanagawa (JP)

(21) Appl. No.: 18/683,511

(22) PCT Filed: Jul. 29, 2022
(86) PCT No.: PCT/JP2022/029301

§ 371 Date: Feb. 14, 2024

Related U.S. Application Data
(60) Provisional application No. 63/234,715, filed on Aug. 19, 2021.

(51) Int. Cl. H02K 1/16

(52) U.S. Cl. CPC H02K 1/165; H02K 2213/03

(57) ABSTRACT

A stator core has tooth portions each including a body and an umbrella portion. The umbrella portion includes a first vertex closest to one side in the circumferential direction in a surface facing the side end and the other side in the radial direction, a second vertex farthest from the side end portion toward the one side in the circumferential direction, a third vertex closest to the other side in the circumferential direction in a surface facing the other side in the radial direction, and a fourth vertex farthest from the side end portion toward the other side in the circumferential direction. Lx is between side end portions facing in the circumferential direction on a virtual straight line passing through the second and fourth vertices, Ly1 is between the side end portion and the second vertex, Ly2 is between the side end portion and the fourth vertex, 0<Ly1/Lx<0.4 and 0<Ly2/Lx<0.4.

### CROSS-REFERENCE TO RELATED APPLICATIONS

This application is the U.S. national stage of application No. PCT/JP2022/029301, filed on Jul. 29, 2022, and priority under 35 U.S.C. § 119 (a) and 35 U.S.C. § 365 (b) is claimed from U.S. Provisional Patent Application No. 63/234, 715, filed on Aug. 19, 2021, the contents of which are incorporated herein by reference.

### FIELD OF THE INVENTION

The present invention relates to a rotary electric machine.

### BACKGROUND

A rotary electric machine having a rotor and a stator is known. For example, in a known configuration, tips of a plurality of tooth portions of a stator core have a trapezoidal shape, and a magnetic flux formed by a coil is prevented from leaking to adjacent tooth portions.

In the rotary electric machine configured as described above, since the slot width, which is the width of the space between the plurality of tooth portions, is widened, leakage of the magnetic flux formed by the coil can be suppressed, and the torque ripple can be reduced. However, in a case where the slot width is wide, when the rotor rotates, a change in the direction of the magnetic flux entering each tooth portion from the rotor tends to be large at the circumferential end portion of each of the plurality of tooth portions, and the cogging torque may be deteriorated.

### SUMMARY

In one aspect of the present invention, an exemplary rotary electric machine includes a rotor rotatable about a central axis, and a stator disposed on one side in the radial direction of the rotor. The rotor includes a rotor core extending along the central axis, and a magnet fixed to the rotor core. The stator includes a stator core radially facing the rotor with a gap interposed therebetween, and a coil portion mounted on the stator core. The stator core has a core back portion having an annular shape with the central axis as a center, and a plurality of tooth portions disposed along a surface facing the other side in the radial direction of the core back portion. A slot in which a part of the coil portion is disposed is provided between the tooth portions adjacent to each other in the circumferential direction. Each of the plurality of tooth portions includes a tooth body portion extending from a surface facing the other side in the radial direction of the core back portion to the other side in the radial direction, and an umbrella portion connected to a tip portion of the tooth body portion and protruding to both sides in the circumferential direction from the tooth body portion. When viewed in the axial direction, the umbrella portion includes a side end portion located on an extension line of an outer side surface facing the circumferential direction of the teeth main body portion, a first vertex located closest to one side in the circumferential direction in a surface facing the other side in the radial direction, a second vertex that is a portion farthest from the side end portion toward the one side in the circumferential direction in a surface located on the one side in the circumferential direction with respect to the side end portion, a third vertex located closest to the other side in the circumferential direction in a surface facing the other side in the radial direction, and a fourth vertex that is a portion farthest from the side end portion toward the other side in the circumferential direction in a surface located on the other side in the circumferential direction with respect to the side end portion. In the rotary electric machine, assuming a virtual straight line passing through the second vertex and the fourth vertex facing each other in the circumferential direction via the slot when viewed in the axial direction, a first distance Lx, which is a distance on the virtual straight line between the side end portions of a pair of umbrella portions facing each other in the circumferential direction through the slot, a second distance Ly1, which is a distance between the side end portion and the second vertex in each umbrella portion, and a third distance Ly2, which is a distance between the side end portion and the fourth vertex in each umbrella portion, satisfy the following expressions.

$$\begin{matrix}0 < Ly 1 / Lx < 0. 4 \\ 0 < Ly 2 / Lx < 0. 4\end{matrix}$$

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a rotary electric machine of one embodiment;

FIG. 2 is a sectional view, taken along a line II-II in FIG. 1, illustrating the rotary electric machine according to one embodiment;

FIG. 3 is a cross-sectional view illustrating a part of the rotary electric machine according to one embodiment;

FIG. 4 is a diagram illustrating cogging torque and torque ripple of the rotary electric machine according to one embodiment; and

FIG. 5 is another diagram illustrating cogging torque and torque ripple of the rotary electric machine according to one embodiment.

### DETAILED DESCRIPTION

The drawings each illustrate a Z-axis appropriately in the below description. The Z-axis indicates a direction in which a central axis J of a rotor 20 of an embodiment described below extends. The central axis J illustrated in each drawing is a virtual axis. In the below description, a direction in which the central axis J extends, or a direction parallel to the Z-axis, is referred to as an “axial direction”. A radial direction about the central axis J is simply referred to as a “radial direction”. Of the radial direction, a side away from the central axis J is referred to as “radially outer side” or “one side in the radial direction”. Of the radial direction, a side approaching the central axis J is referred to as “radially inner side” or “the other side in the radial direction”. A circumferential direction about the central axis J is simply referred to as a “circumferential direction”. Of the axial direction, a side where the arrow of the Z-axis is directed (+Z side) is referred to as an “upper side”. Of the axial direction, a side opposite to the side where the arrow of the Z-axis is directed (−Z side) is referred to as a “lower side”. The upper side and the lower side are simply terms for describing a relative positional relationship of components, and thus an actual placement relationship and the like may be other than the placement relationship and the like indicated by these terms.

The circumferential direction is indicated by an arrow θ in each drawing. Of the circumferential direction, a side where the arrow θ faces is referred to as “one side in the circumferential direction”. Of the circumferential direction, a side opposite to the side where the arrow θ faces is referred to as “the other side in the circumferential direction”. The one side in the circumferential direction is a side proceeding clockwise around the central axis J (+θ side) when viewed from the upper side (+Z side). The other side in the circumferential direction is a side proceeding counterclockwise around the central axis J (−θ side) when viewed from the upper side.

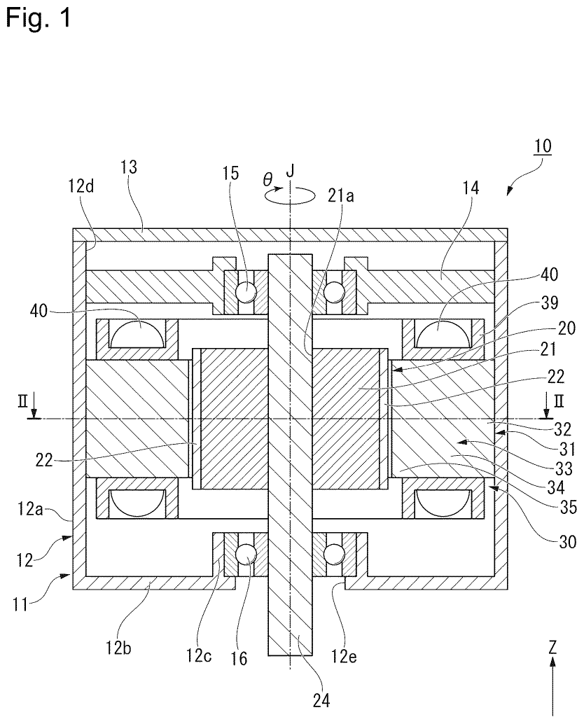

The rotary electric machine 10 illustrated in FIG. 1 is applied as a motor to be attached to equipment such as an automatic transmission mounted on a vehicle and a drive device that drives an axle of the vehicle. The rotary electric machine 10 includes a housing 11, a rotor 20, a stator 30, a first bearing 15, and a second bearing 16.

The housing 11 accommodates the rotor 20, the stator 30, the first bearing 15, and the second bearing 16 therein. The housing 11 includes a cylindrical portion 12, an upper cover portion 13, and a first bearing holding portion 14. The cylindrical portion 12 has a cylindrical shape extending in the axial direction with the central axis J as the center. The cylindrical portion 12 opens upward. The cylindrical portion 12 includes a side wall portion 12a, a lower wall portion 12b, and a second bearing holding portion 12c.

The side wall portion 12a has a substantially cylindrical shape extending in the axial direction with the central axis J as the center. The side wall portion 12a radially surrounds the rotor 20, the stator 30, the first bearing 15, and the second bearing 16. An opening portion 12d that opens upward is provided at an upper end of the side wall portion 12a.

The lower wall portion 12b has an annular plate shape centered on the central axis J. The plate surface of the lower wall portion 12b faces the axial direction. The radially outer end of the lower wall portion 12b is connected to the lower end of the side wall portion 12a. The lower wall portion 12b is provided with a lower wall hole 12e axially penetrating the lower wall portion 12b. The lower wall hole 12e is a substantially circular hole centered on the central axis J.

The second bearing holding portion 12c protrudes upward from the lower wall portion 12b. The second bearing holding portion 12c has a substantially cylindrical shape centered on the central axis J. The second bearing 16 is held on the inner peripheral surface of the second bearing holding portion 12c.

The upper cover portion 13 has a substantially disk shape centered on the central axis J. The plate surface of the upper cover portion 13 faces the axial direction. The upper cover portion 13 is fixed to an upper end of the cylindrical portion 12. The upper cover portion 13 closes the opening portion 12d from above.

The first bearing holding portion 14 is fixed to a portion of the inner peripheral surface of the side wall portion 12a above the rotor 20 and the stator 30. The first bearing holding portion 14 has a substantially annular shape centered on the central axis J. The first bearing 15 is held on the inner peripheral surface of the first bearing holding portion 14.

The rotor 20 is rotatable about the central axis J. The rotor 20 includes a rotor core 21, a plurality of magnets 22, and a shaft 24.

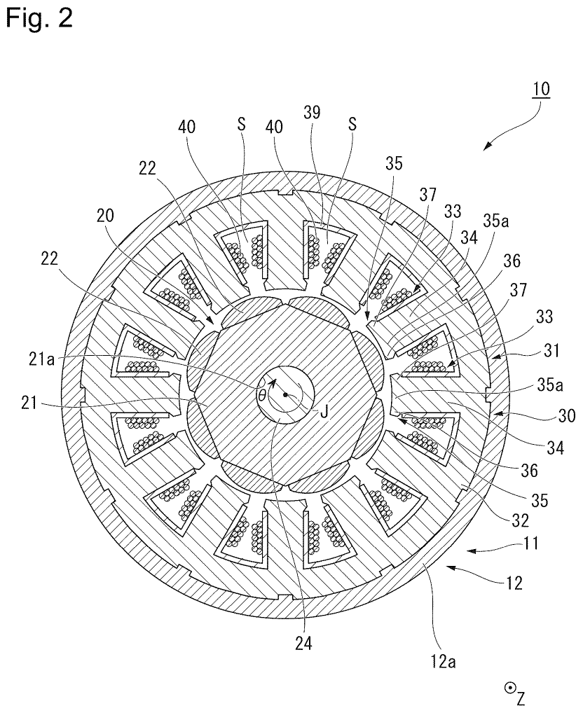

The rotor core 21 extends along the central axis J. The rotor core 21 radially surrounds the shaft 24. For example, the rotor core 21 is a laminated steel sheet formed by laminating a plurality of electromagnetic steel sheets in the axial direction. As illustrated in FIG. 2, the rotor core 21 has a polygonal shape when viewed in the axial direction. In the present embodiment, the rotor core 21 has a substantially octagonal shape when viewed in the axial direction. The rotor core 21 is provided with a through hole 21a.

As illustrated in FIG. 1, the through hole 21a is a hole that penetrates the rotor core 21 in the axial direction. The through hole 21a is a substantially circular hole centered on the central axis J. The shaft 24 is inserted into the through hole 21a. The shaft 24 is fixed to the inner peripheral surface of the through hole 21a. As a result, the rotor core 21 is fixed to the shaft 24.

As illustrated in FIG. 2, each of the plurality of magnets 22 is fixed to an outer surface of the rotor core 21 facing radially outward. Each of the plurality of magnets 22 faces the stator 30 in the radial direction. In the present embodiment, a surface facing radially outward of each of the plurality of magnets 22 has an arc shape. The surface facing radially outward of each of the plurality of magnets 22 may have another shape such as a planar shape. The plurality of magnets 22 are arranged at intervals in the circumferential direction. In the present embodiment, eight magnets 22 are provided.

As illustrated in FIG. 1, the shaft 24 has a substantially cylindrical shape extending in the axial direction about the central axis J. As described above, the shaft 24 is fixed to the through hole 21a of the rotor core 21. An upper portion of the shaft 24 is supported by the first bearing 15. The lower end of the shaft 24 protrudes to the outside of the housing 11 through the lower wall hole 12e. A lower portion of the shaft 24 is supported by the second bearing 16. The shaft 24 is rotatably supported about the central axis J by the first bearing 15 and the second bearing 16. Accordingly, the rotor 20 is rotatable about the central axis J.

The first bearing 15 rotatably supports an upper portion of the shaft 24. The second bearing 16 rotatably supports a lower portion of the shaft 24. In the present embodiment, the first bearing 15 and the second bearing 16 are ball bearings. The first bearing 15 and the second bearing 16 may be rolling bearings other than ball bearings, or plain bearings.

The stator 30 is disposed radially outside the rotor 20, that is, on one side in the radial direction. The stator 30 faces the rotor 20 in the radial direction with a gap therebetween. The stator 30 is fixed to the side wall portion 12a. The stator 30 includes a stator core 31, an insulator 39, and a plurality of coil portions 40.

The stator core 31 has an annular shape extending in the axial direction around the central axis J. The stator core 31 faces the rotor 20 in the radial direction with a gap therebetween. For example, the stator core 31 is a laminated steel sheet formed by laminating a plurality of electromagnetic steel sheets in the axial direction. The stator core 31 includes a core back portion 32 and a plurality of tooth portions 33.

As illustrated in FIG. 2, the core back portion 32 has a substantially annular shape centered on the central axis J. The outer peripheral surface of the core back portion 32 is fixed to the inner peripheral surface of the side wall portion 12a. Accordingly, the stator 30 is fixed to the housing 11.

Each of the plurality of tooth portions 33 extends radially inward from the core back portion 32. Each of the plurality of tooth portions 33 faces the rotor 20 with a gap therebetween in the radial direction. The plurality of tooth portions 33 are arranged at intervals along the radially inner side of the core back portion 32, that is, the surface facing the other side in the radial direction. In the present embodiment, twelve tooth portions 33 are provided. A slot S is provided between the tooth portions adjacent to each other in the circumferential direction. The slot S is a space between the tooth portions 33 adjacent to each other in the circumferential direction. In the present embodiment, twelve slots S are provided. Each of the plurality of tooth portions 33 includes a tooth body portion 34 and an umbrella portion 35.

The tooth body portion 34 extends radially inward from the radially inner side of the core back portion 32, that is, a surface facing the other side in the radial direction. The tooth body portion 34 has a substantially rectangular shape when viewed in the axial direction. A plurality of the tooth body portions 34 are provided at intervals along the circumferential direction. In the present embodiment, twelve tooth body portions are provided.

The umbrella portion 35 is connected to a tip portion that is a radially inner end of the tooth body portion 34. The umbrella portion 35 protrudes toward both sides in the circumferential direction from the tooth body portion 34. The umbrella portion 35 faces the magnet 22 with a gap in the radial direction. A plurality of the umbrella portions 35 are provided at intervals along the circumferential direction. In the present embodiment, twelve umbrella portions 35 are provided. The shape and the like of the umbrella portion 35 will be described later in detail.

The insulator 39 insulates the stator core 31 from the plurality of coil portions 40. The insulator 39 is attached to the plurality of tooth portions 33 and the core back portion 32.

Each of the plurality of coil portions 40 is attached to each of the tooth portions 33 via the insulator 39. In the present embodiment, twelve coil portions 40 are provided. A part of each coil portion is disposed in the slot S. A current is supplied from an external power supply (not illustrated) to each of the coil portions 40. When a current is supplied to each of the coil portions 40, each of the coil portions 40 constitutes an electromagnet.

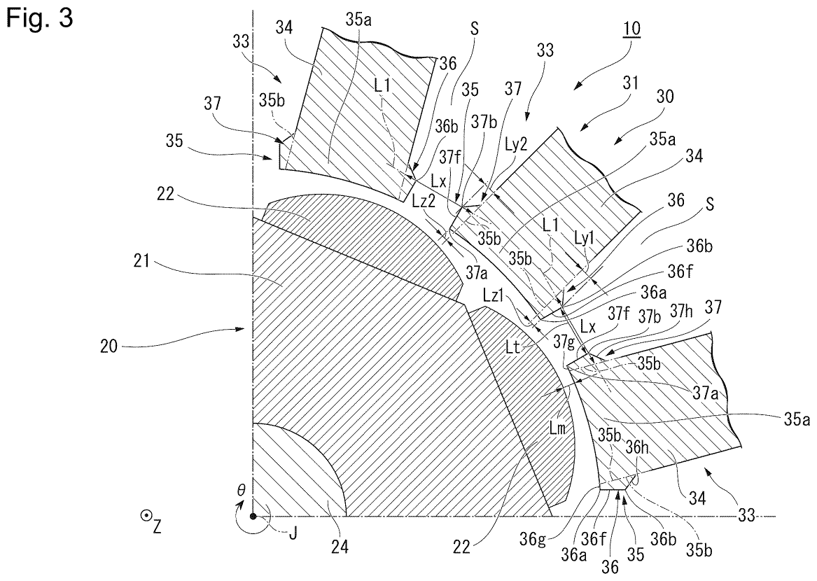

The umbrella portion 35 includes a base portion 35a, a first protruding portion 36, and a second protruding portion 37. As illustrated in FIG. 3, the base portion 35a is a portion of the umbrella portion 35 located radially inside the tooth body portion 34. The radially outer end of the base portion 35a is connected to the radially inner end of the tooth body portion 34. When viewed in the axial direction, a surface of the base portion 35a facing radially inside has a substantially arc shape centered on the central axis J. The base portion 35a is provided with side end portions 35b of the first protruding portion 36 and the second protruding portion 37 respectively. The side end portion 35b is located at each end on both sides in the circumferential direction of the base portion 35a. When viewed in the axial direction, the side end portion 35b is a portion of the base portion 35a located on an extension line of the outer surface facing the circumferential direction of the tooth body portion 34.

The first protruding portion 36 protrudes to one side in the circumferential direction from the side end portion 35b located on one side in the circumferential direction (+θ side). When viewed in the axial direction, the first protruding portion 36 has a substantially trapezoidal shape with the side end portion 35b as one side of the base. The first protruding portion 36 includes a first vertex 36a, a second vertex 36b, a first side surface portion 36f, a second side surface portion 36g, and a third side surface portion 36h. The first side surface portion 36f, the second side surface portion 36g, and the third side surface portion 36h are surfaces located on one side in the circumferential direction with respect to the side end portion 35b.

The first side surface portion 36f is a surface disposed on one side in the circumferential direction (+θ side) with respect to the side end portion 35b, of the outer surfaces of the first protruding portion 36. The first side surface portion 36f is disposed away from the side end portion 35b. In the present embodiment, the first side surface portion 36f faces a direction between one side in the circumferential direction and the radially inner side. The first side surface portion 36f connects the first vertex 36a and the second vertex 36b.

The second side surface portion 36g is a surface facing the radially inner side, that is, the other side in the radial direction, of the outer surfaces of the first protruding portion 36. When viewed in the axial direction, the second side surface portion 36g has a substantially arc shape centered on the central axis J. An end on the other side in the circumferential direction (−θ side) of the second side surface portion 36g is connected to an end on one side in the circumferential direction (+θ side) of the surface of the base portion 35a facing radially inward. The end on one side in the circumferential direction of the second side surface portion 36g is connected to an end on the radially inner side of the first side surface portion 36f. The second side surface portion 36g connects the first vertex 36a and the radially inner end of the side end portion 35b.

The third side surface portion 36h is a surface facing the radially outer side, that is, a direction between one side in the radial direction and one side in the circumferential direction (+θ side), of the outer surfaces of the first protruding portion 36. The radially inner end of the third side surface portion 36h is connected to the radially outer end of the first side surface portion 36f. The third side surface portion 36h connects the second vertex 36b and the radially outer end of the side end portion 35b.

When viewed in the axial direction, the first vertex 36a is a portion located closest to one side (+θ side) in the circumferential direction in the plane of the second side surface portion 36g. The first vertex 36a is the radially inner end of the first side surface portion 36f. The distance between the side end portion 35b of the first protruding portion 36 and the first vertex 36a in each umbrella portion 35 is a fourth distance Lz1.

When viewed in the axial direction, the second vertex 36b is a portion that is farthest from the side end portion 35b toward the one side in the circumferential direction in a plane located on the one side (+01 side) in the circumferential direction from the side end portion 35b. The second vertex 36b is the radially outer end of the first side surface portion 36f. The second vertex 36b is the radially inner end of the third side surface portion 36h. The distance between the side end portion 35b of the first protruding portion 36 and the second vertex 36b in each umbrella portion 35 is a second distance Ly1.

The second protruding portion 37 protrudes to the other side in the circumferential direction from the side end portion 35b located on the other side in the circumferential direction (−θ side). When viewed in the axial direction, the second protruding portion 37 has a substantially trapezoidal shape with the side end portion 35b as one side of the base. The second protruding portion 37 includes a third vertex 37a, a fourth vertex 37b, a fourth side surface portion 37f, a fifth side surface portion 37g, and a sixth side surface portion 37h. The fourth side surface portion 37f, the fifth side surface portion 37g, and the sixth side surface portion 37h each are surfaces located on the other side in the circumferential direction with respect to the side end portion 35b.

The fourth side surface portion 37f is a surface disposed on the other side in the circumferential direction (−θ side) with respect to the side end portion 35b, of the outer surfaces of the second protruding portion 37. The fourth side surface portion 37f is disposed away from the side end portion 35b. In the present embodiment, the fourth side surface portion 37f faces a direction between the other side in the circumferential direction and the radially inner side. The fourth side surface portion 37f connects the third vertex 37a and the fourth vertex 37b.

The fifth side surface portion 37g is a surface facing the radially inner side, that is, the other side in the radial direction, of the outer surfaces of the second protruding portion 37. When viewed in the axial direction, the fifth side surface portion 37g has a substantially arc shape centered on the central axis J. An end on the one side in the circumferential direction (+θ side) of the fifth side surface portion 37g is connected to an end on the other side in the circumferential direction (−θ side) of the surface of the base portion 35a facing radially inward. An end on the other side in the circumferential direction of the fifth side surface portion 37g is connected to an end on the radially inner side of the fourth side surface portion 37f. The fifth side surface portion 37g connects the third vertex 37a and the radially inner end of the side end portion 35b.

The sixth side surface portion 37h is a surface facing the radially outer side, that is, a direction between the one side in the radial direction and the other side (−θ side) in the circumferential direction, of the outer surfaces of the second protruding portion 37. An end on the radially inner side of the sixth side surface portion 37h is connected to an end on the radially outer side of the fourth side surface portion 37f. The sixth side surface portion 37h connects the fourth vertex 37b and the radially outer end of the side end portion 35b.

When viewed in the axial direction, the third vertex 37a is a portion located closest to the other side (−θ side) in the circumferential direction in the plane of the fifth side surface portion 37g. The third vertex 37a is the radially inner end of the fourth side surface portion 37f. The distance between the side end portion 35b of the second protruding portion 37 and the third vertex 37a in each umbrella portion 35 is a fifth distance Lz2. In the present embodiment, since the tooth portion 33 has a symmetrical shape with the center line of the tooth portion 33 as viewed in the axial direction, the fifth distance Lz2 is equal to the fourth distance Lz1.

When viewed in the axial direction, the fourth vertex 37b is a portion that is farthest from the side end portion 35b toward the other side in the circumferential direction in the plane located on the other side (−θ1 side) in the circumferential direction from the side end portion 35b. The fourth vertex 37b is the radially outer end of the fourth side surface portion 37f. The fourth vertex 37b is the radially inner end of the sixth side surface portion 37h. The distance between the side end portion 35b of the second protruding portion 37 and the fourth vertex 37b in each umbrella portion 35 is a third distance Ly2. In the present embodiment, since the tooth portion 33 has a symmetrical shape with the center line of the tooth portion 33 as viewed in the axial direction, the third distance Ly2 is equal to the second distance Ly1.

A virtual straight line L1 illustrated in FIG. 3 is a straight line passing through the second vertex 36b and the fourth vertex 37b circumferentially facing each other via the slot S when viewed in the axial direction. Among the distances between the side end portions 35b of the pair of umbrella portions 35 facing each other in the circumferential direction via the slot S, the distance on the virtual straight line L1 is the first distance Lx. In other words, the first distance Lx is a distance on the virtual straight line L1 between the side end portions 35b of the first protruding portion 36 and the second protruding portion 37 facing each other in the circumferential direction via the slot S. In the present embodiment, the first distance Lx and the second distance Ly1 satisfy the following Expression (1).

$$0 < Ly 1 / Lx < 0. 4 \qquad ( 1 )$$

Moreover, in the present embodiment, the first distance Lx and the third distance Ly2 satisfy the following Expression (2).

$$0 < Ly 2 / Lx < 0. 4 \qquad ( 2 )$$

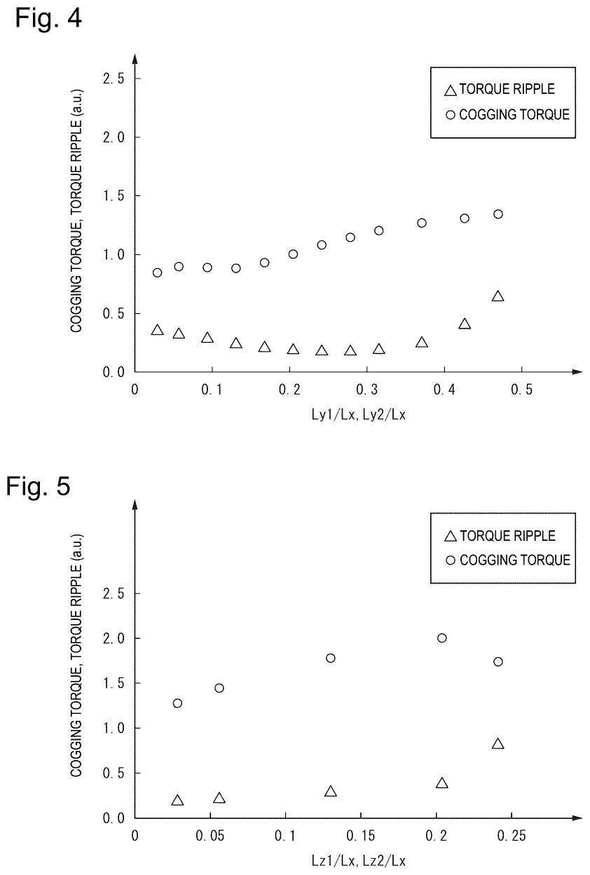

FIG. 4 is a diagram illustrating a relationship between Ly1/Lx and Ly2/Lx and cogging torque and torque ripple of the rotary electric machine 10. The horizontal axis represents Ly1/Lx and Ly2/Lx. The vertical axis represents the cogging torque and the torque ripple. In the present embodiment, the target torque of the cogging torque is 1.78 or less. As illustrated in FIG. 4, the torque ripple is substantially constant when the Ly1/Lx and Ly2/Lx are between 0 and 0.4. When Ly1/Lx and Ly2/Lx become larger than 0.4, the torque ripple rapidly increases. When Ly1/Lx and Ly2/Lx are between 0 and 0.4, the cogging torque is 1.78 or less.

Therefore, according to the present embodiment, the first distance Lx and the second distance Ly1 satisfy Expression (1), and the first distance Lx and the third distance Ly2 satisfy Expression (2). Therefore, in the pair of tooth portions 33 arranged adjacent to each other in the circumferential direction, the dimension of the interval between the umbrella portions 35 can be set to a dimension of 20% or more of the first distance Lx which is the dimension between the side end portions 35b. Therefore, the magnetic flux of the electromagnet formed of the coil portion 40 attached to each tooth portion 33 can be prevented from leaking to the tooth portions 33 arranged adjacent to each other in the circumferential direction via the umbrella portions 35 arranged adjacent to each other in the circumferential direction. Accordingly, the magnetic flux density of the magnetic flux entering the rotor 20 from each tooth portion 33 can be stabilized, and the torque ripple of the rotary electric machine 10 can be suppressed.

Further, according to the present embodiment, the umbrella portion 35 includes the first vertex 36a located closest to the one side (+θ side) in the circumferential direction in the plane facing the other side in the radial direction, and the second vertex 36b that is a portion farthest from the side end portion 35b toward the one side in the circumferential direction in the plane located on the one side in the circumferential direction from the side end portion 35b. As a result, the first side surface portion 36f connecting the first vertex 36a and the second vertex 36b faces a direction between the radially inner side and the one side in the circumferential direction. In addition, the umbrella portion 35 includes the third vertex 37a located closest to the other side (−θ side) in the circumferential direction in the surface facing the other side in the radial direction, and the fourth vertex 37b that is a portion farthest from the side end portion 35b toward the other side in the circumferential direction in the surface located on the other side in the circumferential direction from the side end portion 35b. As a result, the fourth side surface portion 37f connecting the third vertex 37a and the fourth vertex 37b faces a direction between the radially inner side and the other side in the circumferential direction. Therefore, when the rotor 20 rotates about the central axis J, the direction of the magnetic flux entering the first side surface portion 36f and the fourth side surface portion 37f from the magnet 22 of the rotor 20 can be made closer to the radial direction at both circumferential ends of the tooth portion 33. The magnetic flux entering the second side surface portion 36g, the surface of the base portion 35a facing the radially inner side, and the fifth side surface portion 37g from the magnet 22 faces the radial direction. Therefore, when the rotor 20 rotates about the central axis J, it is possible to suppress a rapid change in the direction of the magnetic flux entering the tooth portion 33 from the magnet 22 at both circumferential ends of the tooth portion 33. Therefore, the cogging torque of the rotary electric machine 10 can be suppressed.

Accordingly, in the rotary electric machine 10 of the present embodiment, the torque ripple and the cogging torque can be suppressed.

As illustrated in FIG. 3, in the present embodiment, the first distance Lx and the fourth distance Lz1 satisfy the following Expression (3).

$$0 < Lz 1 / Lx < 0.13 \qquad ( 3 )$$

Moreover, in the present embodiment, the first distance Lx and the fifth distance Lz2 satisfy the following Expression (4).

$$0 < Lz 2 / Lx < 0.13 \qquad ( 4 )$$

FIG. 5 is a diagram illustrating a relationship between Lz1/Lx and Lz2/Lx and cogging torque and torque ripple of the rotary electric machine 10. The horizontal axis represents Lz1/Lx and Lz2/Lx. The vertical axis represents the cogging torque and the torque ripple. As illustrated in FIG. 5, the torque ripple is substantially constant when the Lz1/Lx and Lz2/Lx are between 0 and 0.13. When Lz1/Lx and Lz2/Lx become larger than 0.2, the torque ripple rapidly increases. When Lz1/Lx and Lz2/Lx are between 0 and 0.13, the cogging torque is 1.78 or less, which is equal to or less than the target torque described above.

According to the present embodiment, the first distance Lx and the fourth distance Lz1 satisfy Expression (3), and the first distance Lx and the fifth distance Lz2 satisfy Expression (5). Therefore, since the first vertex 36a can be easily disposed on the other side (−θ side) in the circumferential direction with respect to the second vertex 36b, the direction in which the first side surface portion 36f faces can be made closer to the radially inner side. In addition, since the third vertex 37a is easily disposed on the other side (+θ side) in the circumferential direction with respect to the fourth vertex 37b, the direction in which the fourth side surface portion 37f faces can be made closer to the radially inner side. Therefore, when the rotor 20 rotates about the central axis J, the direction of the magnetic flux entering the first side surface portion 36f and the fourth side surface portion 37f from each magnet 22 of the rotor 20 can be made further closer to the radial direction at both circumferential ends of the tooth portion 33. Therefore, when the rotor 20 rotates about the central axis J, a change in the direction of the magnetic flux entering the tooth portion 33 from the magnet 22 can be more suitably suppressed at both circumferential ends of the tooth portion 33, and the cogging torque can be more suitably suppressed. Accordingly, in the rotary electric machine 10 of the present embodiment, the torque ripple and the cogging torque can be suppressed.

As illustrated in FIG. 3, when viewed in the axial direction, a distance Lt between the second vertex 36b and the fourth vertex 37b facing each other via the slot S is larger than a distance Lm of a radial gap between the rotor 20 and the tooth portion 33. Therefore, according to the present embodiment, the magnetic flux of the electromagnet formed by the coil portion 40 attached to each tooth portion 33 easily enters the inside of the rotor core 21 via the magnet 22. Therefore, the magnetic flux of the electromagnet formed by the coil portion 40 can be prevented more suitably from leaking to the tooth portions 33 arranged adjacent to each other in the circumferential direction via the umbrella portions 35 arranged adjacent to each other in the circumferential direction. Accordingly, the magnetic flux density of the magnetic flux entering the rotor 20 from each tooth portion 33 can be further stabilized, and the torque ripple of the rotary electric machine 10 can be suppressed more suitably.

In the present embodiment, since the magnetic flux density of the magnetic flux entering each tooth portion 33 from each magnet 22 of the rotor 20 can be increased, the torque efficiency of the rotary electric machine 10 can be increased.

According to the present embodiment, the umbrella portion 35 includes the second side surface portion 36g that connects the first vertex 36a and the side end portion 35b and faces the radially inner side, that is, the other side in the radial direction, and the fifth side surface portion 37g that connects the third vertex 37a and the side end portion 35b and faces the radially inner side. Therefore, when the rotor 20 rotates about the central axis J, the direction of the magnetic flux entering the umbrella portion 35 from the magnet 22 of the rotor 20 can be made closer to the radial direction. Accordingly, the cogging torque of the rotary electric machine 10 can be more suitably suppressed.

In the present embodiment, the umbrella portion 35 includes the third side surface portion 36h facing the radially outer side, that is, the direction between the one side in the radial direction and the one side (+θ side) in the circumferential direction, and the sixth side surface portion 37h facing the direction between the radially outer side and the other side (−θ side) in the circumferential direction. Therefore, it is possible to prevent the magnetic flux of the magnet 22 from entering the tooth portion 33 from the third side surface portion 36h and the sixth side surface portion 37h. Therefore, when the rotor 20 rotates about the central axis J, the magnetic flux of the magnet 22 easily enters the tooth portion 33 from the first side surface portion 36f and the second side surface portion 36g at both ends in the circumferential direction of the tooth portion 33. Therefore, when the rotor 20 rotates about the central axis J, a change in the direction of the magnetic flux entering the tooth portion 33 from the magnet 22 can be more suitably suppressed at both circumferential ends of the tooth portion 33, and the cogging torque of the rotary electric machine 10 can be suppressed.

The present invention is not limited to the above-described embodiment, and other configurations and other methods can be employed within the scope of the technical idea of the present invention. For example, the number of tooth portions included in the stator core is not limited to twelve, and may be eleven or less or thirteen or more.

The number of magnets included in the rotor is not limited to eight, and may be seven or less, or may be nine or more.

The tooth portion may not have a symmetrical shape with the center line of the tooth portion as a symmetry line when viewed in the axial direction, and the shape of the first protruding portion and the shape of the second protruding portion may have an asymmetrical shape with the center line of the tooth portion as a symmetry line.

The rotary electric machine may be a rotary electric machine having an outer rotor configuration in which the stator is disposed on the radially inner side of the rotor, the radially outer end portion of the stator core faces the rotor, and the tooth portion protrudes radially outward.

A rotary electric machine to which the present invention is applied is not limited to a motor, and may be a generator. The purpose of the rotary electric machine is not particularly limited. The rotary electric machine may be mounted on a vehicle for uses other than the use of rotating an axle, or may be mounted on equipment other than a vehicle.

The structures described above in the present description may be appropriately combined in a range where no conflict arises.

Note that the present technique can have the following configurations.
(1) A rotary electric machine comprising: a rotor rotatable about a central axis; and a stator disposed on one side in a radial direction of the rotor, wherein the rotor includes a rotor core extending along the central axis, and a magnet fixed to the rotor core, the stator includes a stator core radially facing the rotor with a gap, and a coil portion mounted on the stator core, the stator core includes a core back portion that is in an annular shape and is centered on the central axis, and a plurality of tooth portions disposed along a surface of the core back portion facing another side in a radial direction, the rotary electric machine further comprises a slot in which a part of the coil portion is disposed, the slot being provided between the tooth portions adjacent to each other in a circumferential direction, each of the plurality of tooth portions includes: a tooth body portion extending from a surface facing another side in a radial direction of the core back portion toward another side in a radial direction; and an umbrella portion connected to a tip portion of the tooth body portion and protruding to both sides in a circumferential direction from the tooth body portion, and when viewed in an axial direction, the umbrella portion includes: a side end portion located on an extension line of an outer side surface of the tooth body portion facing a circumferential direction; a first vertex located closest to one side in a circumferential direction in a plane facing another side in a radial direction; a second vertex that is a portion farthest from the side end portion toward one side in a circumferential direction in a plane located on the one side in the circumferential direction with respect to the side end portion; a third vertex located closest to another side in a circumferential direction in a plane facing another side in a radial direction; and a fourth vertex that is a portion farthest from the side end portion toward another side in a circumferential direction in a plane located on another side in a circumferential direction with respect to the side end portion, and assuming a virtual straight line passing through the second vertex and the fourth vertex facing each other in a circumferential direction via the slot when viewed in an axial direction, a first distance Lx, which is a distance on the virtual straight line between the side end portions of a pair of the umbrella portions facing each other in a circumferential direction via the slot, a second distance Ly1, which is a distance between the side end portion and the second vertex in each of the umbrella portions, and a third distance Ly2, which is a distance between the side end portion and the fourth vertex in each of the umbrella portions, satisfy the following expressions.

$$\begin{matrix}0 < Ly 1 / Lx < 0. 4 \\ 0 < Ly 2 / Lx < 0. 4\end{matrix}$$

(2) The rotary electric machine according to (1), wherein a fourth distance Lz1 that is a distance between the side end portion and the first vertex in each of the umbrella portions and a fifth distance Lz2 that is a distance between the side end portion and the third vertex satisfy the following expressions.

$$\begin{matrix}0 < Lz 1 / Lx < 0. 13 \\ 0 < Lz 2 / Lx < 0. 13\end{matrix}$$

(3) The rotary electric machine according to (1) or (2), wherein when viewed in an axial direction, a distance between the second vertex and the fourth vertex facing each other via the slot is larger than a distance of a radial gap between the rotor and the tooth portion.
(4) The rotary electric machine according to any one of (1) to (3), wherein the umbrella portion includes: a first side surface portion connecting the first vertex and the second vertex; a second side surface portion connecting the first vertex and the side end portion and facing another side in a radial direction; a third side surface portion connecting the second vertex and the side end portion and facing a direction between one side in a radial direction and one side in a circumferential direction; a fourth side surface portion connecting the third vertex and the fourth vertex; a fifth side surface portion connecting the third vertex and the side end portion and facing another side in a radial direction; and a sixth side surface portion connecting the fourth vertex and the side end portion and facing a direction between the one side in a radial direction and another side in a circumferential direction.

The rotary electric machine according to the present invention is applicable as a motor attached to equipment such as an automatic transmission mounted on a vehicle and a drive device that drives an axle of a vehicle.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotary electric machine comprising:
a rotor rotatable about a central axis; and
a stator disposed on one side in a radial direction of the rotor,
wherein the rotor includes a rotor core extending along the central axis, and a magnet fixed to the rotor core,
the stator includes a stator core radially facing the rotor with a gap, and a coil portion mounted on the stator core,
the stator core includes a core back portion that is in an annular shape and is centered on the central axis, and a plurality of tooth portions disposed along a surface of the core back portion facing another side in a radial direction,
the rotary electric machine further comprises a slot in which a part of the coil portion is disposed, the slot being provided between the tooth portions adjacent to each other in a circumferential direction,
each of the plurality of tooth portions includes:
a tooth body portion extending from a surface facing another side in a radial direction of the core back portion toward another side in a radial direction; and
an umbrella portion connected to a tip portion of the tooth body portion and protruding to both sides in a circumferential direction from the tooth body portion, and
when viewed in an axial direction, the umbrella portion includes:
a side end portion located on an extension line of an outer side surface of the tooth body portion facing a circumferential direction;
a first vertex located closest to one side in a circumferential direction in a plane facing another side in a radial direction;
a second vertex that is a portion farthest from the side end portion toward one side in a circumferential direction in a plane located on one side in a circumferential direction with respect to the side end portion;
a third vertex located closest to another side in a circumferential direction in a plane facing another side in a radial direction; and
a fourth vertex that is a portion farthest from the side end portion toward another side in a circumferential direction in a plane located on another side in a circumferential direction with respect to the side end portion, and
assuming a virtual straight line passing through the second vertex and the fourth vertex facing each other in a circumferential direction via the slot when viewed in an axial direction, a first distance Lx, a second distance Ly1, and a third distance Ly2 satisfy following expressions:
$$\begin{matrix}0 < Ly 1 / Lx < 0. 4 \\ 0 < Ly 2 / Lx < 0. 4\end{matrix}$$
where the first distance Lx is a distance on the virtual straight line between the side end portions of a pair of the umbrella portions facing each other in a circumferential direction via the slot,
the second distance Ly1 is a distance between the side end portion and the second vertex in each of the umbrella portions, and
the third distance Ly2 is a distance between the side end portion and the fourth vertex in each of the umbrella portions.

2. The rotary electric machine according to claim 1, wherein a fourth distance Lz1 that is a distance between the side end portion and the first vertex in each of the umbrella portions and a fifth distance Lz2 that is a distance between the side end portion and the third vertex satisfy the following expressions:
$$\begin{matrix}0 < Lz 1 / Lx < 0.13 \\ 0 < Lz 2 / Lx < 0.13 .\end{matrix}$$

3. The rotary electric machine according to claim 1, wherein when viewed in an axial direction, a distance between the second vertex and the fourth vertex facing each other via the slot is larger than a distance of a radial gap between the rotor and the tooth portion.

4. The rotary electric machine according to claim 1-or 2, wherein the umbrella portion includes:
a first side surface portion connecting the first vertex and the second vertex;
a second side surface portion connecting the first vertex and the side end portion and facing another side in a radial direction;
a third side surface portion connecting the second vertex and the side end portion and facing a direction between one side in a radial direction and one side in a circumferential direction;
a fourth side surface portion connecting the third vertex and the fourth vertex;
a fifth side surface portion connecting the third vertex and the side end portion and facing another side in a radial direction; and
a sixth side surface portion connecting the fourth vertex and the side end portion and facing a direction between one side in a radial direction and another side in a circumferential direction.
